(19) United States
(12) Patent Application Publication
(10) Pub. No.: US 2016/0082525 A1
(43) Pub. Date: Mar. 24, 2016

(54) MULTI-EDGE DRILL BIT

(71) Applicant: Sainty International, LLC, Ventura, CA (US)

(72) Inventor: Haining Gao, Nanjing (CN)

(21) Appl. No.: 14/604,558

(22) Filed: Jan. 23, 2015

(30) Foreign Application Priority Data
Sep. 24, 2014 (CN) 201420553095.5

(51) Int. Cl. B23B 51/04

(52) U.S. Cl. CPC B23B 51/04; B23B 2251/122; B23B 2251/14; B23B 2251/20

(57) ABSTRACT

A multi-edge drill bit includes a drill body and a drill tip at one end of the drill body. The drill tip includes two main cutting edges extending to outside and symmetric about a center of the drill body and two crescent grooves symmetric about the center. Each of the crescent grooves intersects with corresponding main cutting edge respectively to divide the main cutting edge into an outer edge, an arc edge, and an inner edge. A transverse edge is formed between the two inner edges and has its middle point forming the core bit. The outer edges intersect with said arc edges to form two symmetric side bits. A ratio of the vertical distance between the core bit and the side bit to drill diameter is 0.02 to 0.03 and a ratio of the transverse edge length to drill diameter is 0.05 to 0.08. The drill bit as described herein provides a stable centering effect during drilling and facilitates continuous stable drilling in round pipe and thin plate applications.

### CROSS-REFERENCE TO RELATED APPLICATIONS

This application claims the benefit of the priority date of Chinese Application No. 201420553095.5, filed Sep. 24, 2014, which is incorporated herein in its entirety.

### FIELD

A type of drilling tool is described, and in particular, a type of a multi-edge drill bit configured to fit on a drilling tool.

### BACKGROUND

Multi-edge drill bits may be obtained by grinding two symmetric crescent grooves in the cutting part of a standard twist drill, forming arc edges, and grinding the transverse edge and the core bit to form two inner straight edges. With the transverse edge and existing two outer straight edges, the standard twist drill of “one bit and three edges” is ground to “3-bit, 7-edge” drill.

Pages 213 to 241 of “Cluster drill—Lizhifu drill” (Li Zhifu, Chen Biguang et al., Shanghai Science & Technology Publishing House, September 1999) disclose structural characteristics and main geometric parameters of a basic type of cluster drill. This is a structure with one core bit, two side bits, two inner edges, two arc edges, two outer edges, and one transverse edge, forming 3-bit, 7-edge type drill bit. In this cluster drill, the ratio of core bit height to drill diameter is calculated to be 0.035 to 0.047, the ratio of transverse edge length to drill diameter is calculated to be 0.035 to 0.047, and the ratio of horizontal distance between core bit and side bit to drill diameter is calculated to be 0.24 to 0.33. Transverse edge bevel angle is 60° to 65°, inner edge bevel angle is 20° to 30°, inner edge rake angle is −15° to −10°, inner edge sharp angle is ≈135°, and outer edge sharp angle is ≈125°. The ratio of arc edge radius to drill diameter is calculated to be 0.1 to 0.18.

Chinese patent document CN202180241U discloses a type of general purpose multi-edge drill bit comprising a drill tip, a drill body connected to this drill tip, and an edge band provided on drill body outer wall. Each of the two main cutting edges of the drill tip includes (from outside to inside) an outer edge, an arc edge, and an inner edge. Between the two inner edges is the transverse edge at center of the drill tip. Each outer edge intersects with corresponding arc edge to form a chip separation bit. The two sides of the transverse edge and front of each inner edge enclose an apex. Inner edge sharp angle is 108° to 128°, outer edge sharp angle is 130° to 140°, and inner edge bevel angle is 28° to 40°.

Although the two types of drill bits described above have improved centering capability, drilling capability, and durability, they have the following two disadvantages. First, it takes longer time to form stable 3-bit centering during drilling before which the drill is subject to axial offset, which lowers drilling precision and drill durability. Second, drilling stability is poor when machining work piece of uneven surface, due to relatively short transverse edge.

### SUMMARY

The present application solves the above-discussed technical issues by providing a type of 7-edge drill bit capable of fast centering and stable continuous drilling.

In one embodiment, the technical scheme for achieving such a solution includes a 7-edge drill bit comprising a drill body and a drill tip at one end of said drill body; wherein on said drill tip, two main cutting edges extending to outside and symmetric about a center of the drill body and two crescent grooves symmetric about the center are provided; wherein each said crescent groove intersects with corresponding main cutting edge respectively to divide it into an outer edge, an arc edge, and an inner edge (from outside to inside); wherein a transverse edge is formed between said two inner edges and has its middle point forming the core bit; wherein said outer edges intersect with said arc edges to form two symmetric side bits; wherein the ratio of vertical distance between said core bit and said side bit to drill diameter is 0.02 to 0.03; wherein the ratio of transverse edge length to drill diameter is 0.05 to 0.08.

In one approach, to achieve optimum drilling stability, an optimization of the above technical scheme is that the ratio of said transverse edge length to drill diameter is 0.07.

In an embodiment, a further optimization of aforesaid technical scheme is that the ratio of the horizontal distance between said core bit and side bit to drill diameter is 029 to 0.31. Without wishing to be limited by theory, the increase of the width of crescent grooves improves chip discharge capability. If coolant is used, this may also allow the coolant to fully enter the cutting face, thus improving cooling effect.

In one embodiment, to achieve optimum drilling effect and improve durability, a further optimization of this technical scheme is that the ratio of horizontal distance between said core bit and side bit to drill diameter is 0.3.

Yet another further optimization of aforesaid technical scheme according to one embodiment is that the bevel angle of said transverse edge is 50° to 60°, which may increase the strength of the core bit and the cutting force.

Still another further optimization of aforesaid technical scheme according to one embodiment is that the bevel angle of said inner edges is 20° to 35°, which provides moderate length of inner edges and good effect of chip separation, discontinuation, and discharge.

In one form, a further optimization of aforesaid technical scheme is that the rake angle of said inner edges is 2° to 6°, which increases the drill bit strength and axial stability, while increasing cutting force.

In another form, a further optimization of aforesaid technical scheme is that the ratio of said arc edge radius to drill diameter is 0.1 to 0.15, which may allow good chip discharge.

Another further optimization of aforesaid technical scheme according to one embodiment is that the sharp angle of said inner edges is 110° to 125°, which may ensure good cutting force and centering capability of the drill.

Yet another further optimization of aforesaid technical scheme is that the sharp angle of said outer edges is 130° to 140°, which is advantageously applicable to relatively hard metal materials.

Some of the beneficial effects of the technical solution described herein include:

(1) Based on existing twist drill, in the 7-edge drill bit as described herein, the core bit is partially retracted, so that when drilling on thin plate or work piece of uneven surface, the core bit and the two symmetric side bits can quickly achieve stable 3-bit centering, and the drill is not subject to axial offset, thus improving drilling precision and drill durability.

(2) In the 7-edge drill bit of this utility model, the transverse edge length is suitably increased, ensuring core bit strength and stable centering effect, while improving drilling stability, making it suitable for work pieces of uneven machining surface.

### BRIEF DESCRIPTION OF THE DRAWINGS

The following further describes embodiments of this invent on in combination with the following figures.

FIG. 1 is a schematic of a front elevational view of the structure of a drill bit according to one preferred embodiment.

FIG. 2 is a schematic of top plan view of the structure of the drill bit of FIG. 1.

In above figures, the numbers indicate the following:

1 is a drill body, w is a drill tip, 21 is an outer edge, 22 is an arc edge, 23 is an er edge, 24 is a transverse edge, 25 is a core bit, and 26 is a side bit.

### DETAILED DESCRIPTION

The following is a particular description of preferred embodiments of a drill bit. It is worth noting that the following preferred embodiments are provided by way of example only, and shall not be understood as limiting the scope of the technical solution described herein. Except otherwise defined, all professional and scientific terms used in this document shall have the same meanings as well known by those of ordinary skill in this technical field. Detailed information regarding the technical terms in this field may be obtained from “Cluster drill—Lizhifu drill” (Li Zhifu, Chen Biguang et al., Shanghai Science & Technology Publishing House, September 1999), incorporated by reference herein.

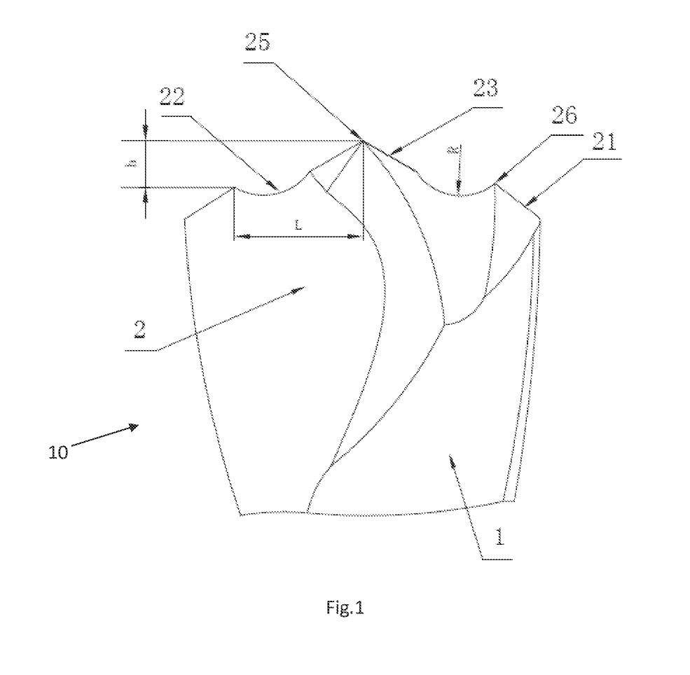

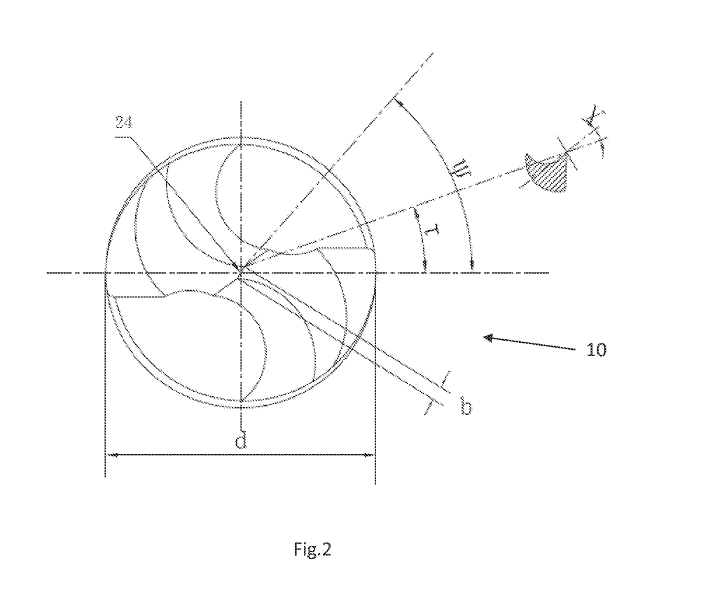

As shown in FIG. 1 and FIG. 2, a 7-edge drill bit 10 of this preferred embodiment is obtained through processing of an ordinary twist drill. The drill bit 10 comprises drill body 1 and drill tip 2 at one end of said drill body 1. In one approach, a cutting part of twist drill is ground to form two symmetric crescent grooves, each of which intersects with corresponding main cutting edge to divide this edge into one outer edge 21 and one arc edge 22 (from outside to inside). Two sharp inner edges 23 may be formed by further thinning. Between these two inner edges 23, one narrow transverse edge 24 is formed as seen in FIG. 2, with a middle point of this transverse edge 24 forming core bit 25. Outer edges 21 intersect with corresponding arc edges 22 to form two symmetric side bits 26. In the illustrated embodiment, the ratio of vertical distance between said core bit 25 and said side bit 26 to drill diameter is 0.02, while the ratio of length of said transverse edge 24 to drill diameter is 0.07.

In a preferred embodiment, the ratio of horizontal distance between said core bit 25 and said side bit 26 to drill diameter is 0.3. In this embodiment, the bevel angle of said transverse edge 24 is 50°, the bevel angle of said inner edges 23 is 20°, the rake angle of said inner edges 23 is 2°, the ratio of said arc edge 22 radius to drill diameter is 0.1, the sharp angle of said inner edges 23 is 125°, and the sharp angle of said outer edges 23 is 135°.

The 7-edge drill bit according to another preferred embodiment is the same as that of preferred embodiment 1, except that the ratio of the vertical distance between said core bit 25 and said side bit 26 to drill diameter is 0.03 and the ratio of said transverse edge 24 length to drill diameter is 0.08.

The 7-edge drill bit according to yet another preferred embodiment is the same as that of preferred embodiment 1, except that the ratio of vertical distance between said core bit 25 and said side bit 26 to drill diameter is 0.25 and the ratio of said transverse edge 24 length to drill diameter is 0.05.

The 7-edge drill bit as described herein is not limited to the preferred embodiments described above. All technical schemes that adopt equivalent replacements and modifications of the structures described herein fall within the scope of protection encompassed by this application.

What is claimed is:

1. A drill bit, comprising:
a drill body and a drill tip at one end of said drill body, the drill tip including two main cutting edges extending outwardly and symmetrically about a center of the drill body and two crescent grooves symmetric about the center;
wherein each of said crescent grooves intersects with a corresponding main cutting edge to divide said main cutting edge into a plurality of outer edges, arc edges, and inner edges;
wherein a transverse edge is formed between two of said inner edges, a middle point of the transverse edge forming said core bit;
wherein said outer edges intersect with said arc edges to form two symmetric side bits;
wherein a ratio of a vertical distance between said core bit and said side bit to drill diameter is 0.02 to 0.03; and
wherein a ratio of a length of said transverse edge to drill diameter is 0.05 to 0.08.

2. The drill bit according to claim 1, wherein the ratio of the length of said transverse edge to said drill diameter is 0.07.

3. The drill bit according to claim 1, wherein the ratio of horizontal distance between said core bit and said side bit to drill diameter is 0.29 to 0.31.

4. The drill bit according to claim 3, wherein a ratio of a horizontal distance between said core bit and said side bit to said drill diameter is 0.3.

5. The drill bit according to claim 1, wherein a bevel angle of said transverse edge is 50° to 60°.

6. The drill bit according to claim 1, wherein a bevel angle of said inner edges is 20° to 35°.

7. The drill bit according to claim 1, wherein a rake angle of said inner edges is 2° to 6°.

8. The drill bit according to claim 1, wherein a ratio of radius of said arc edges to said drill diameter is 0.1 to 0.15;

9. The drill bit according to claim 1, wherein a sharp angle of said inner edges is 110° to 125°.

10. The drill bit according to one of claim 1, wherein a sharp angle of said outer edges is 130° to 140°.
